(19) United States
(12) Patent Application Publication
(10) Pub. No.: US 2001/0008695 A1
(43) Pub. Date: Jul. 19, 2001

(54) POLYMER FILMS AND LAMINATES THEREOF

(76) Inventors: NELSON BOLTON, TRUMBAUERSVILLE, PA (US); W. NOVIS SMITH, PHILADELPHIA, PA (US)

Correspondence Address: JOHN LEZDEY & ASSOCIATES, 1018 LAUREL OAK ROAD, SUITE 4, VOORHEES, NJ, 08043

(21) Appl. No.: 09/178,281

(22) Filed: Oct. 23, 1998

(51) Int. Cl. B32B 17/10; B32B 27/30

(52) U.S. Cl. 428/442; 428/412; 428/483; 428/494; 428/520

(57) ABSTRACT

The present inventions teaches an optically transparent film or sheet of an extruded acrylic copolymer or terpolymer and polyethylene having a melting point of less than 275° F. and a haze not more than 5%. The resin film can be used alone or in a lamination with other polymers or glass so that the combination has a haze less than 6%.

### BACKGROUND OF THE INVENTION

1. Field of the Invention

This invention relates to extruded low melting resins and transparent resin films. In particular, the invention relates to extruded acrylic copolymer and terpolymer films for use alone or in laminates, including laminated glass, and further for laminating dissimilar materials.

2. Description of the Prior Art

Safety glass can be reinforced by lamination with an inner layer of polycarbonate. The resulting lamination, however, is impractical for two principal reasons. First, there is insufficient bond strength when polycarbonate is bonded directly to glass. Second, and more importantly polycarbonate and glass have different coefficients of thermal expansion. The polycarbonate can crack and craze on cooling from the temperature necessary to bond the two together because of the different thermal expansion coefficients of the components. In safety glass laminates having polycarbonate, the polycarbonate must be bonded to glass by means of a clear thermoplastic inner layer.

Initial attempts to solve these problems involved interposing additional interlayers of polyvinyl butyral (PVB) between the polycarbonate and the glass. However, adhesion between the polycarbonate and the glass with the PVB proved inadequate even with a plasticizer in the PVB. Moreover, even when a plasticizer was used it often caused the polycarbonate to develop stress cracks, which resulted in low light transmission properties and loss of structural properties. Some of these problems were resolved by using the laminated safety glass described in U.S. Pat. No. 3,888,032, which is herein incorporated by reference, which has achieved wide commercial success. The '032 laminate includes polycarbonate reinforced glass wherein the polycarbonate and glass are bonded to one another by an interlayer of aliphatic polyurethane. Polyurethane provides sufficient adhesion to glass and to the polycarbonate and no stress cracking or cloudiness develops in the product.

Despite the commercial success of the aliphatic polyurethane laminated product, there has been a continuing effort to develop less expensive products, particularly since aliphatic polyurethane is an expensive component. Aliphatic polyurethane also does not have the high impact strength of polycarbonate. To solve this problem, the present invention teaches a low haze transparent article comprising a resin film, with and without layers of polycarbonates, and other reinforcing transparent plastics, which is considerably less expensive than the aliphatic polyurethane laminates, yet which at the same time is every bit as satisfactory, if not more so, with regard to adhesion, strength and clarity. Moreover, the resin film of this invention has significantly higher impact resistance than aliphatic polyurethane and about equal impact resistance in comparison to polycarbonate. This means that the low haze film taught by the present invention can be used either with or without polycarbonate and still provide high impact transparencies.

This invention describes the use of a class of polymeric compositions for the manufacture of optically transparent windows, transparencies and impact resistant windows either singularly or in combination with other transparent materials such as optical grade glass, polycarbonate, acrylic, polyester, and fluorocarbon films. The prior art compositions develop more haze as the thickness increases due to slower cooling of the laminate after the heated lamination cycle which permits crystallites to form in the plastic layer. On the other hand, the polymers taught by the present invention can be used in thicknesses of greater than or equal to 0.5 mm when laminated or used alone and still provide a low haze product. Surprisingly, these polymers can also provide low haze products at thicknesses of greater than 0.75 mm.

In the specification and claims of this patent, the terms “ionomer” and “ionomer resin” mean an extrudable resin comprising ionically crosslinked ethylene-methacrylic acid and ethylene-acrylic acid copolymers. The starting ionomer resins are generally available as either a partially neutralized sodium, lithium or zinc ionomer and are available in a wide variety of grades.

Various grades of the resins are available for extrusion coatings and film extrusion. The term “film” includes single layers and laminates. It is also known that resins of the invention can be co-extruded with other plastic resins or ionomers and exhibit adhesion to other polyolefin resins, nylon resins and coextrudable adhesive resins often used as bonding layers in multiply coextruded structures.

U.S. Pat. No. 5,569,722 to Wang et al, which is herein incorporated by reference discloses low haze ionomers of copolymers of alpha-olefins, carboxylic acid esters and optional comonomers which are prepared in a reactive extruder and treated with an acid to impart acidity.

U.S. Pat. Nos. 4,663,228 and 4,619,974 to Bolton et al., which is hereby incorporated by reference, was the first prior art reference to suggest that ionomer resins along with a polyamine could be used for reinforcing glass layers in order to form a laminated safety glass. The '228 patent discloses that ionomer resins could be generally substituted for polyurethanes, acrylics and polycarbonates. Moreover, prior to the '228 patent it had been generally assumed that ionomer resin films thicker than 0.5 mm could not be obtained which still maintained optical clarity of at least 60% light transmission, which translates into a haze reading of less than 5.0%. Moreover, acceptable haze for transparencies should be preferably less than 3.5% and most preferably, less than 1%.

Layers of the copolymers and terpolymers of the invention can be formed by casting, forming blown film or extrusion, the latter one being preferred for process advantages. However, once formed, there are no significant differences between cast, blown and extruded layers. If the polymeric or resin layer can be made sufficiently thick without interfering with optical clarity, an unsupported film can be provided. The present invention teaches a sufficiently thick resin layer which can be used in a laminate with ionomer resins.

The resins of the invention have several advantages over polyurethane. Polyurethane is difficult to manufacture, expensive and hard to fabricate. The present resin films can be easily extruded to desired thicknesses. Furthermore, the present resin films cost about one-half of the material cost of polyurethane. Moreover, the resins have demonstrated excellent adhesion characteristics to glass, ionomers and polycarbonates, as well as better resistance to lower temperatures and good impact resistance.

The ionomer resin layers, for example, as disclosed in the '228 patent, cannot make low haze, 0.5 mm thick optically transparent films or laminates without the inclusion of an polyamine. While ionomers containing polyamines offer a viable alternative, they do not bond strongly to polycarbonate.

Therefore, the primary object of this present invention is to provide a low melting optically transparent copolymers and terpolymers which overcome the prior art limitations and disadvantages.

It is another object of this invention to provide a laminated article composed of glass and resins, and depending upon the application, laminates of glass, resin and polycarbonate or other high impact transparent plastics as well which have low haze. The laminated articles of the invention have all of the advantages and positive features of laminates of glass and polyurethane and polycarbonate, but are significantly less expensive to produce and have other enhanced features such as increased clarity and more stability to delamination.

It is yet another object of this invention to provide a laminated article of glass and high impact plastic which has good adhesion and which is transparent and resistant to breakage.

It is still another object of this invention to provide a laminated article of glass and high impact plastic which has good strength properties over a wide temperature range.

### SUMMARY OF THE INVENTION

These and other objects of this invention are accomplished by providing an extrudable acrylic resin film which can be used alone or in a lamination to a sheet of glass and/or high plastic transparency, such as acrylic or polycarbonate. The preferable copolymer and terpolymer resin films are ethylene-methyl acrylate or acrylic ester with inclusion of acrylic acid or salts of acrylic acid or methacrylic acid thereof having more than 23% combined content in the form of the acrylic acid, methacrylic acid, esters or acrylic salts thereof, a polyethylene content less than 77% and a haze not more than 5%. The laminated articles may also comprise a sheet of transparent plastic laminated to the polymeric film opposite the glass. The laminated articles may further comprise the resin film sandwiched between two sheets of glass. Furthermore, the laminated articles may include a sheet of the resin film sandwiched between a sheet of glass and a sheet of plastic or the resin film sandwiched between a sheet of glass and a sheet of metal. The laminated articles may also comprise any number of lamina of glass sandwiched with a lamina of the resin, the resultant laminate having glass as the outer lamina. Moreover, the multi-layer laminate of glass and resin may have a glass/resin configuration, with glass as the exterior layer and the resin as the interior layer, the interior layer having further a polyester film layer laminated thereto on the side opposite the glass layer. The laminates have a haze less than 6%.

Advantageously, the copolymers or terpolymers contain 23% or more acrylic esters monomers and less than 77% of the ethylene bonds so as to provide greater transparency and low haze in thick sections.

The present invention teaches a transparent article, which includes an extrudable resin film or sheet. The preferred resin has an acrylic monomer content of between about 23% and 40% by weight in the form of acrylic acid, methacrylic acid or esters or salts thereof. The present invention is especially adaptable to different applications as it can be used alone or in laminations with polycarbonate and glass or other transparent polymer film layers.

The advantages and objects of the present invention will become evident by referring to the following description and claims.

### DESCRIPTION OF THE PREFERRED EMBODIMENTS

When films of copolymers and terpolymers of ethylene-methyl acrylate and methacrylic acid or ethylene-acrylic acid have previously been formed, they usually only retained their clarity when formed in very thin films. Thin films help insure the clarity of the films because the thin layered films can be cooled quickly after being melted and formed. Rapid cooling prevents the formation of finely dispersed crystallites from being formed, which would create a hazy film and result in poor light transmission film properties. In thicker films and sheets of the resin, the degree of clarity becomes an important problem since a larger mass of the film cools more slowly which allows the crystallites a greater opportunity to form and grow. These crystallites create haze and opacity due to the polyethylene segments. In fact, sheets of 1 mm or thicker are not obtained with clarity under normal cooling conditions. Furthermore, prior to the present invention, sheets of 0.5 mm or thicker which were processed under normal cooling conditions resulted in undesirable haze readings of greater than 6%. Moreover, the haze readings were significantly worse, and therefore, even more undesirable, in sheets of 0.75 mm or thicker. Rapid quenching of the thick layers can help, but rapid quenching becomes impossible or at least very difficult if the copolymer or terpolymer sheet is laminated or is a part of a larger object. When transparent windshields are made from prior art ionomer films, some means is required in order to prevent the crystallites from forming and creating the resulting haze in the film during processing and cooling.

U.S. Pat. No. 5,763,062 has addressed the haze formation in ionomers by using high levels of methacrylic acid. U.S. Pat. No. 4,619,974 has attempted to solve the problem by employing polyamines. However, ionomers have poor adhesion to polycarbonate. It has now been found that similar copolymers and terpolymers of polyethylene and methyl acrylate provide the advantages of low haze and good adhesion to both glass and polycarbonate.

The present invention teaches that extrudable resin films of methyl acrylate copolymers and terpolymers, which contain between 23% and 40% of a methyl acrylate and acrylic acid or methacrylic acid or other monomer containing acrylic acid, such as salts thereof, and the balance ethylene, exhibit low haze, namely, less than 6% haze, when used in sheets of greater than 0.5 mm without requiring ionic crosslinking as provided by high acid content or amines. As mentioned above, such low haze is a requirement when using plastics for optical transparencies and is not seen in the prior art in thicknesses that are greater than 0.5 mm. Normally, resins which are extruded into thick sheet sections, e.g., greater than 0.3 mm, will undergo partial crystallization of the polyethylene segment. This partial crystallization produces various degrees of haze on cooling which results in poor optical qualities. In order to reduce or eliminate this crystallization of the polyethylene segment, the glass transition temperature (T_{g}) of the polymer must be raised closer to or above the temperature where crystallization starts because the crystallization temperature is related to the melting point or the melting depressed below the T_{g}. An elevation in the T_{g} or lowering of the melting point in the resin will result in lower haze.

When used in laminates such as with glass or polycarbonate, the haze is less than 6% for the laminate with the films of the invention. The extruded optically transparent films of the invention have a melting point less than 275° F. and can be used to bond dissimilar films to form a transparent laminate. The films comprise methyl acrylate, acrylic or methacrylic acid or other ester copolymers or terpolymers having a total acrylic monomer content of about 23% to 40% by weight and a polyethylene level less than 77%.

These films can be formed as a separate phase on at least one face of an ionomer sheet by coextrusion, laminates or stacking of the sheets of the two polymers.

It is important that the films used in this invention are extruded. Extrusion provides total homogeneity prior to cool down which results in a more uniform and consistent product. Previous prior art attempts including producing a milled product using additives did not result in achieving sufficient temperatures to produce a totally melted resin which is necessary for total homogeneity of the resin. Therefore, the milled product required a high T_{g} to achieve low haze on cooling. Accordingly, milling cannot provide a full reaction at normal operating temperatures because of the high viscosity of the reactants. The physical shearing forces of milling cannot break the ionic bonds at normal operating temperatures. In contrast, the extrudable resins contemplated by the present invention provide a full reaction that is easy to accomplish at the normal operating high temperatures (above 275° F.). Advantageously, laminations are done at temperatures higher than or equal to 250° F.

Thus, the formation of low haze polymeric sheets is possible even when the sections are greater than 0.5 mm thick. The thicker the section, the slower it cools, and therefore, the more time there is for crystallization of the polyethylene segments in the polymer to produce haze before the temperature goes below the crystallization/melting point. Since the higher methyl acrylate and lower polyethylene content causes crystallization and a temperature drop, less haze is formed in the polymers of the invention. When the temperature of the polymer goes below the glass transition point, the formation of crystallites cannot proceed because the resin is frozen into a “glass”. The higher the T_{g} is above the melting point, the less the polyethylene crystallites can form. Therefore, although low haze can sometimes be achieved on thin films of various copolymers and ionomers, we have found that when the methyl acrylate content, or the combined acrylic acid, ester or acrylic acid salt content, is above 23%, the sheets of copolymers and terpolymers that can be formed with low haze can be made thicker and therefore, more suitable for optical transparencies. Preferably, the polymeric sheets in the laminates are about 0.2 to 10 mm in thickness.

The combined acrylic monomer content in the copolymers or terpolymers are preferably between about 23% and 40% by weight. The resin film or sheet of the invention can be used alone or in a lamination in thickness of up to 0.5 mm or greater and still exhibit low haze properties of less than 6% haze.

Preferably, the resins contain acrylic monomers such as copolymers and terpolymers of ethylene-methyl acrylate, acrylic acid, methylmethacrylate, methacrylic acid and mixtures thereof or salts. Moreover, the resins are preferably prepared from monomers, copolymers and terpolymers of the same acrylic monomers. Preferable, is the inclusion of a copolymerized olefin such as ethylene in the resin.

Certain embodiments of the invention can advantageously utilize a variety of partially neutralized esterified acid polymers such as polyethylene acrylic acid/ester and polyethylene methacrylic acid/ester.

An ionomer resin is coextruded with the resin of the invention in a film or sheet which can be used alone or in a lamination. In laminations, the coextruded resin is preferably laminated to a sheet of polycarbonate or primed or unprimed glass with the sheet or surface of the resin of the present invention facing the polycarbonate. It can also face the glass. Such a lamination can -be further modified by a second sheet of polycarbonate or primed or unprimed glass. Preferably, each polycarbonate or glass sheet has a thickness of at least about 0.7 mm. Along with the resin sheet, the total lamination is about 2 mm thick. In fact, we have found that exceptionally thick laminations of over 8 mm, which are especially useful in automotive glass applications, can be produced with the resins of the present invention. For example, one such lamination was produced with a laminated sheet of ionomer having a layer of the resin of the present invention on both sides forming a laminated sheet of at least 4 mm thick and two polycarbonate or glass sheets, each one having a thickness of at least 2 mm.

The present invention encompasses laminating transparent glass and plastic sheets together. The resins are also used for laminating transparent polycarbonate or acrylic sheets to glass or other transparent structures. Furthermore, the resins can be used to form laminated optically transparent sheets at thicknesses greater than 220 mm as windows, bullet resistant shields and other high impact protective transparencies.

The resins of the invention can be used to bond to at least one film layer of polycarbonate, ionomer, glass, acrylic polymers such as polyethylene-methacrylic acid or esters, polyolefin such as polyethylene, polyester, halogenated polymers such as fluorinated polymers, polyvinyl chloride, FEP and PFA, polystyrene, polyurethane and neoprene.

The resin films, containing 23% or more of acrylic ester monomers and less than 78% olefin or ethylene, bond to polycarbonate sheet and glass as well as other transparent substances with an adhesion strength greater than 1200 psi. These resins also have low haze, less than 6% as well as high impact strength.

Following are some examples of the present invention:

### EXAMPLE 1

A 0.75 mm thick sheet of the resin of the invention to be tested is cut into a 150 mm by 150 mm square and placed between two pieces of standard soda lime window glass (2.7 mm×150 mm×150 mm) forming a laminated sandwich. All surfaces of these plates have been previously cleaned and examined carefully to ensure that there is no dirt, other contaminants or lint present. The three-layered sandwich is then placed into a heat resistant vacuum bag and fitted with a vacuum tube and pulled down to a vacuum of 28 inches mercury. The evacuated bag containing the sandwich is then placed into an autoclave which is pressured on the outside of the bag to 14 atmospheres. The autoclave is then heated to 250° F. over 30 minutes while maintaining pressure on the outside of the bagged laminate while vacuum is still maintained on the inside of the vacuum bag by means of the vacuum hose. The autoclave is held at 250° F. for an additional 30 minutes and then the heat is cut off. The autoclave is then placed on a cooling cycle and then opened after 30 minutes. The bagged laminate is then removed and the bag is removed. The three-layered laminate is cleaned on the outside in case any contamination of the outside glass surfaces occurred during handling. This laminate is then placed into a Byk-Gardner Haze Guard Plus Model #4725 meter for determining haze and transmission in transparent sheets. This meter utilizes white light and checks the percent of light dispersion as haze. The percent haze is then recorded for the particular plastic sheet which has been examined. This test shows the expected amount of haze to be formed in commercial applications utilizing plastic sheets to laminate glass and other plastic sheets together or when the plastic sheet itself is used in thicker sections.

### EXAMPLE 2

To produce a glass-resin-glass laminate, two pieces of glass are cut to a predetermined size and an alike sized interlayer made of a copolymer of the invention is cut to match the glass. The interlayer is placed between the two sheets of glass which have had the surface adjacent to the interlayer. The three-layered sandwich is then bagged in a heat resistant vacuum bag. After a vacuum has been accomplished, the bagged laminate is placed in an autoclave. A program to accomplish a first phase is instituted which ramps the autoclave from ambient temperature to about 250° F. A second phase begins in which soaking the sandwich at a chosen temperature is accomplished to allow a softening and melting of the interlayer. A third phase is a ramp down to ambient temperature. During these three phases of production, the autoclave is pressurized with either compressed air or a gas such as nitrogen at 3.5-10 atmospheres of pressure. When the autoclave has been depressurized and the environment in the autoclave has been reduced in temperature to ambient temperature the laminate can be removed and unbagged. The resulting laminate has a haze reading of less than 5%.

### EXAMPLE 3

A copolymer resin which contains about 24% methyl acrylate and 76% ethylene, and was extruded to a sheet of 1 mm and laminated to itself following the procedure of Example 2 to form a 2 mm thick panel. In another instance it was further laminated to a 1 mm thick glass to form an overall 3 mm thick transparency. In both cases, the haze measured was less than 4% and highly suitable for optical transparencies.

### Comparative Example 4

Surlyn® 8920, which contains about 15% methacrylic acid with about 84% ethylene and is about 75% neutralized with a sodium cation, was extruded and laminated in the same manner as described in Example 2 and produced hazy sheets which had haze measurements in excess of 6% which is unsuitable for transparency applications.

### EXAMPLE 5

Various samples were prepared in a twin screw extruder (Welding Engineers), 30:1, 18 mm diameter. The resin pellets were mixed and fed into the extruder by a vibrating screen. The extruder was also equipped with a vent port to release any moisture or gases that were generated. The various resins or reacted/mixed resins were extruded into a sheet about 400 mm wide and about 0.5 mm to about 0.8 mm thick for evaluation of properties. In some cases the mixed resin was extruded into strips or wire and then cut into pellets and then reextruded into sheets.

The extruded sheets were evaluated after 24 hours for haze on a hazemeter and laminated between two pieces of 2.7 mm soda lime window glass in a autoclave and then checked for haze again. This latter lamination test shows the effect of slower cooling through the glass transition point which occurs with the increased mass resulting from the additional glass or plastic being bonded in a lamination. This test demonstrates practical lamination behavior for transparencies. As discussed earlier, with slower cooling, there is more time for crystallization to occur which causes haze.

### EXAMPLE 6

A clean sample of resin sheet prepared from a terpolymer containing 25% methylacrylate, 1% acrylic acid and the remainder ethylene (0.030 in×4″×4″) was laid on top of a clean sheet of ⅛in.×4 in.×4 in. glass and then covered with an identical sheet of glass to form a sandwich. The sample was placed in a heat resistant vacuum bag and placed in an autoclave. The bag was evacuated and the autoclave heated to 255° F. over 30 minutes and held at room temperature for 30 minutes. The heat was cut off and the autoclave cooled to room temperature over 30 minutes. The sample was removed and allowed to totally cool to room temperature for over 2 hours. The haze was then measured on the standard hazemeter as previously described. The laminate had a haze of 3% and an adhesion of 2200 psi to polycarbonate.

### EXAMPLE 7

Following the procedure of Example 6 a copolymer was prepared containing 27% methyl acrylate and the balance polyethylene. The resin was sandwiched between a variety of sheets and tested for haze and adhesion. The results were as follows:

| Sample | Sandwich | Haze % | Adhesion (psi) |
|---|---|---|---|
| A | glass-resin-glass | 2.8 | 1840 |
| B | glass-resin-ionomer | 4.1 | 1548 |
| C | polycarbonate-resin-glass | 4.4 | 1262 |

### EXAMPLE 8

A 9 mils film layer of copolymer consisting of 27% methyl acrylate and the balance polyethylene was laid on the top and bottom of a 20 mils ionomer sheet prepared according to U.S. Pat. No. 4,663,228. A sheet of polycarbonate was then laid on the top and bottom of the stack to form a sandwich. The whole stack was vacuum bagged and heated in an autoclave to 275° F. to effect lamination. After cooling, the laminate was tested for haze and adhesion. The results were as follows:

Haze=4% Adhesion=2100 psi

### EXAMPLE 9

Following the procedure of Example 8, a coextruded sheet consisting of a resin sheet sandwiched between two 9 mils layers of a copolymer consisting of 27% methylacrylate and the balance polyethylene, which had all been coextruded at the same time as a single sheet. The whole stack was vacuum bagged and heated to 275° F. in an autoclave.

The haze was 3% and the adhesion was 2320 psi.

Although the invention has been described herein with a certain degree of particularity, it is understood that the present disclosure has been made only by way of example and that numerous changes in details of construction and the combination and arrangement of ports may be resorted to without departing from the spirit and scope of the invention.

What is claimed is:

1. An extruded optically transparent film comprising an acrylic copolymer or terpolymer resin having a combined acrylic carboxylic acid, ester and acrylic acid salt content of between about 23% and 40% by weight, and an ethylene content less than 77%, said film have a melting point less than 275° F. and a haze not more than about 6%.

2. The film of claim 1 which includes about 0.3% to 10% by weight of an acid selected from the group consisting of acrylic acid and methacrylic acid.

3. The film of claim 1 which includes an acrylate or methacrylate ester.

4. The film of claim 3 wherein said ester is methyl acrylate.

5. An optically transparent laminate comprising at least one optically transparent layer of a material selected from the group consisting of acrylic polymer, polycarbonate, ionomer, glass, halogenated polymer, polyolefin, polyester and polyvinyl butyral, and neoprene bonded to at least one surface of an extruded optically transparent film of claim 1.

6. The laminate of claim 5 comprising a layer of polycarbonate is bonded to a layer of glass by means of a layer of said extruded optically transparent film.

7. The laminate of claim 5 comprising at least one layer of an ionomer bonded to a layer of glass by means of a layer of said extruded optically transparent film.

8. The laminate of claim 5 comprising at least one layer of an acrylic polymer bonded to a layer of glass by means of said extruded optically transparent film.

9. The laminate of claim 5, wherein said resin is prepared from monomers, copolymers or terpolymers selected from the group consisting of ethylene-acrylic acid, ethylene-methacrylic acid, polyacrylic acid, polymethacrylic acid and mixtures thereof.

10. The laminate of claim 9, wherein said monomers, copolymers or terpolymers are at least partially neutralized.
